(19) United States
(12) Patent Application Publication
(10) Pub. No.: US 2023/0032162 A1
(43) Pub. Date: Feb. 2, 2023

(54) CONTROL DEVICE, LIQUID JET HEAD, LIQUID JET RECORDING DEVICE, AND CONTROL PROGRAM

(71) Applicant: Sll Printek Inc., Chiba-shi (JP)

(72) Inventor: Kensuke YOSHIDA, Chiba-shi (JP)

(21) Appl. No.: 17/871,437

(22) Filed: Jul. 22, 2022

(30) Foreign Application Priority Data
Jul. 28, 2021 (JP) 2021-123588

(51) Int. Cl. B41J 2/045

(52) U.S. Cl. CPC B41J 2/04541; B41J 2/04588

(57) ABSTRACT

There are provided a control device and so on capable of achieving an increase in reliability. The control device according to an embodiment of the present disclosure is a control device to be applied to a liquid jet head having a jet section configured to jet liquid, the control device including a determination section configured to determine whether to output a drive signal based on waveform configuration information supplied from an outside of the liquid jet head to the jet section from a drive device configured to generate the drive signal based on the waveform configuration information.

### RELATED APPLICATIONS

This application claims priority to Japanese Patent Application No. 2021-123588, filed on Jul. 28, 2021, the entire content of which is incorporated herein by reference.

### BACKGROUND OF THE INVENTION

### 1. Field of the Invention

The present disclosure relates to a control device, a liquid jet head, a liquid jet recording device, and a control program.

### 2. Description of the Related Art

Liquid jet recording devices equipped with liquid jet heads are used in a variety of fields, and a variety of types of liquid jet heads have been developed (see, e.g., JP-A-2017-170652 (Patent Literature 1)).

In such a liquid jet head, in general, it is required to achieve an enhancement in reliability.

It is desirable to provide a control device, a liquid jet head, a liquid jet recording device, and a control program a reliability enhancement of which can be achieved.

### SUMMARY OF THE INVENTION

A control device according to an embodiment of the present disclosure is a control device to be applied to a liquid jet head having a jet section configured to jet liquid, the control device including a determination section configured to determine whether to output a drive signal based on waveform configuration information supplied from an outside of the liquid jet head to the jet section from a drive device configured to generate the drive signal based on the waveform configuration information.

A liquid jet head according to an embodiment of the present disclosure includes the control device according to the embodiment of the present disclosure, the jet section, and the drive device or a plurality of the drive devices configured to apply the drive signal to the jet section to thereby jet the liquid.

A liquid jet recording device according to an embodiment of the present disclosure includes the liquid jet head according to the embodiment of the present disclosure.

A control program according to an embodiment of the present disclosure is a control program to be applied to a liquid jet head having a jet section configured to jet liquid, the control program including the step of determining whether to output a drive signal based on waveform configuration information supplied from an outside of the liquid jet head to the jet section from a drive device configured to generate the drive signal based on the waveform configuration information.

According to the control device, the liquid jet head, the liquid jet recording device, and the control program related to the embodiment of the present disclosure, it becomes possible to achieve an increase in reliability.

### BRIEF DESCRIPTION OF THE DRAWINGS

FIG. 1 is a block diagram showing an outline configuration example of a liquid jet device according to an embodiment of the present disclosure.

FIG. 2 is a perspective view schematically showing an outline configuration example of a liquid jet head shown in FIG. 1.

FIG. 3 is a cross-sectional view schematically showing a configuration example of the liquid jet head shown in FIG. 2.

FIG. 4 is a block diagram showing a detailed configuration example of the liquid jet head shown in FIG. 1 through FIG. 3.

FIG. 5 is a timing chart showing a configuration example of waveform configuration information shown in FIG. 4.

FIG. 6 is a schematic diagram showing a detailed configuration example of a power supply potential value shown in FIG. 5.

FIG. 7 is a block diagram showing an operation example in the liquid jet head shown in FIG. 4.

FIG. 8 is a block diagram showing another operation example in the liquid jet head shown in FIG. 4.

FIG. 9 is a timing chart showing an example of a first abnormal waveform configuration.

FIG. 10 is a timing chart showing an example of a second abnormal waveform configuration.

FIG. 11 is a timing chart showing an example of a third abnormal waveform configuration.

FIG. 12 is a block diagram showing a configuration example of a liquid jet head related to Modified Example 1.

FIG. 13 is a block diagram showing a configuration example of a liquid jet head related to Modified Example 2.

FIG. 14 is a block diagram showing a configuration example of a liquid jet head related to Modified Example 3.

FIG. 15A is a schematic diagram showing an example of a correspondence relationship between a range of a drive voltage and an operation related to Modified Example 1.

FIG. 15B is a schematic diagram showing an example of a correspondence relationship between a range of a device temperature and an operation related to Modified Example 2.

FIG. 15C is a schematic diagram showing an example of a correspondence relationship between a range of a drive current and an operation related to Modified Example 3.

FIG. 16 is a block diagram showing a configuration example of a liquid jet head related to Modified Example 4.

FIG. 17 is a block diagram showing a configuration example of a liquid jet head related to Modified Example 5.

FIG. 18 is a block diagram showing a configuration example of a liquid jet head related to Modified Example 6.

### DETAILED DESCRIPTION OF THE PREFERRED EMBODIMENTS

An embodiment of the present disclosure will hereinafter be described in detail with reference to the drawings. It should be noted that the description will be presented in the following order.

1. Embodiment (an example of making a determination based on whether to include a predetermined abnormal waveform configuration)

### 2. Modified Examples

Modified Example 1 through Modified Example 3 (an example of making a determination based on values of a drive voltage, a device temperature, and a drive current)

Modified Example 4 (an example of the case of further providing a waveform storing section for storing waveform configuration information)

Modified Example 5 (an example of the case of further providing a waveform correction section for performing correction of the waveform configuration information)

Modified Example 6 (an example of the case in which only a single drive board is disposed in a liquid jet head)

### 3. Other Modified Examples

### 1. EMBODIMENT

### [Outline Configuration of Printer 5]

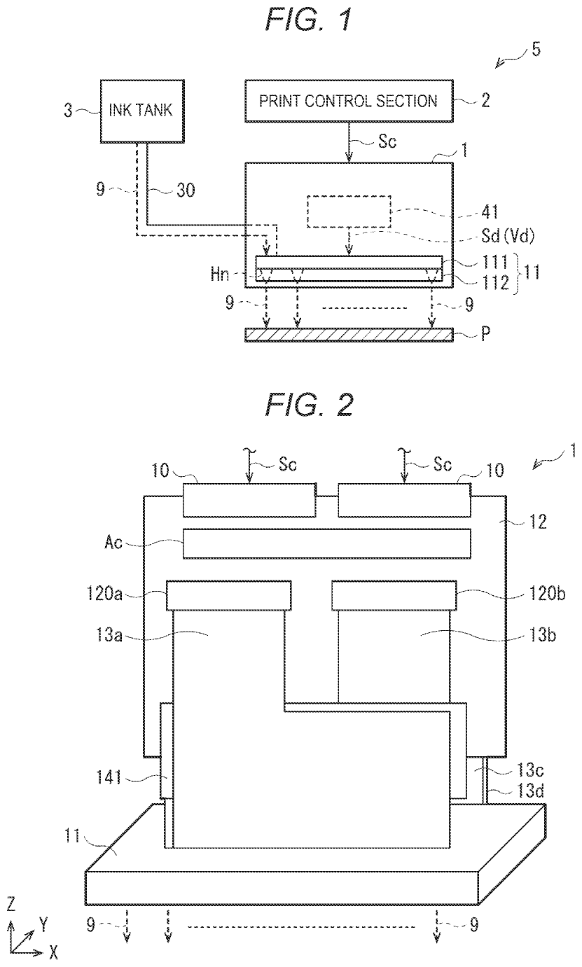

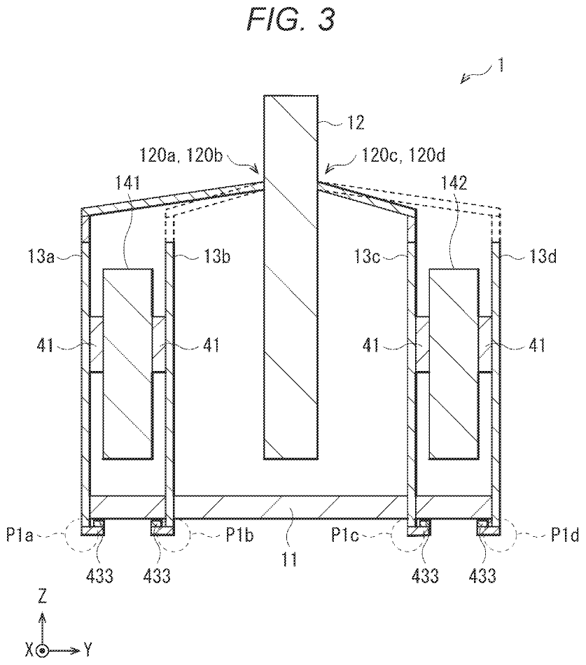

FIG. 1 is a block diagram showing an outline configuration example of a printer 5 as a liquid jet recording device according to an embodiment of the present disclosure. FIG. 2 is a perspective view schematically showing an outline configuration example of an inkjet head 1 as a liquid jet head shown in FIG. 1. FIG. 3 is a cross-sectional view (a Y-Z cross-sectional view) schematically showing a configuration example of the inkjet head 1 shown in FIG. 2. It should be noted that a scale size of each of the members is accordingly altered so that the member is shown in a recognizable size in the drawings used in the description of the present specification.

The printer 5 is an inkjet printer for performing recording (printing) of images, characters, and the like on a recording target medium (e.g., recording paper P shown in FIG. 1) using ink 9 described later. As shown in FIG. 1, the printer 5 is provided with an inkjet head 1, a print control section 2, and an ink tank 3.

It should be noted that the inkjet head 1 corresponds to a specific example of a “liquid jet head” in the present disclosure, and the printer 5 corresponds to a specific example of a “liquid jet recording device” in the present disclosure. Further, the ink 9 corresponds to a specific example of a “liquid” in the present disclosure.

### (A. Print Control Section 2)

The print control section 2 is for supplying the inkjet head 1 with a variety of types of information (data). Specifically, as shown in FIG. 1, the print control section 2 is arranged to supply each of constituents (drive devices 41 described later and so on) in the inkjet head 1 with a print control signal Sc. It should be noted that the print control signal Sc is arranged to include, for example, image data, an ejection timing signal, and a power supply voltage for making the inkjet head 1 operate. Further, the print control section 2 corresponds to a specific example of an “outside of a liquid jet head” in the present disclosure.

### (B. Ink Tank 3)

The ink tank 3 is a tank for containing the ink 9 inside. As shown in FIG. 1, the ink 9 in the ink tank 3 is arranged to be supplied to the inside (a jet section 11 described later) of the inkjet head 1 via an ink supply tube 30. It should be noted that such an ink supply tube 30 is formed of, for example, a flexible hose having flexibility.

### (C. Inkjet Head 1)

As represented by dotted arrows in FIG. 1, the inkjet head 1 is a head for jetting (ejecting) the ink 9 shaped like a droplet from a plurality of nozzle holes Hn described later to the recording paper P to thereby perform recording of images, characters, and so on. As shown in, for example, FIG. 2 and FIG. 3, the inkjet head 1 is provided with a single jet section 11, a single I/F (interface) board 12, four flexible boards 13a, 13b, 13c, and 13d, and two cooling units 141, 142.

### (C-1. I/F Board 12)

As shown in FIG. 2 and FIG. 3, the I/F board 12 is provided with two connectors 10, four connectors 120a, 120b, 120c, and 120d, and a circuit arrangement area Ac.

As shown in FIG. 2, the connectors 10 are each a part (a connector part) for inputting the print control signal Sc described above and supplied from the print control section 2 toward the inkjet head 1 (the flexible boards 13a, 13b, 13c, and 13d described later).

The connectors 120a, 120b, 120c, and 120d are parts (connector parts) for electrically coupling the I/F board 12 and the flexible boards 13a, 13b, 13c, and 13d, respectively.

The circuit arrangement area Ac is an area where a variety of circuits are arranged on the I/F board 12. It should be noted that it is also possible to arrange that such a circuit arrangement area is disposed in other areas on the I/F board 12.

### (C-2. Jet Section 11)

As shown in FIG. 1, the jet section 11 is a part which has the plurality of nozzle holes Hn, and jets the ink 9 from these nozzle holes Hn. Such jet of the ink 9 is arranged to be performed (see FIG. 1) in accordance with drive signals Sd (drive voltages Vd) supplied from the drive devices 41 described later on each of the flexible boards 13a, 13b, 13c, and 13d.

As shown in FIG. 1, such a jet section 11 is configured including an actuator plate 111 and a nozzle plate 112.

### (Nozzle Plate 112)

The nozzle plate 112 is a plate formed of a film material such as polyimide, or a metal material, and has the plurality of nozzle holes Hn described above as shown in FIG. 1. These nozzle holes Hn are formed side by side at predetermined intervals, and each have, for example, a circular shape.

Specifically, in the example of the jet section 11 shown in FIG. 2, the plurality of nozzle holes Hn in the nozzle plate 112 is constituted by a plurality of nozzle arrays (four nozzle arrays) each arranged along the column direction (an X-axis direction). Further, these four nozzle arrays are arranged side by side along a direction (a Y-axis direction) perpendicular to the column direction.

### (Actuator Plate 111)

The actuator plate 111 is a plate formed of a piezoelectric material such as PZT (lead zirconate titanate). The actuator plate 111 is provided with a plurality of channels (pressure chambers). These channels are each a part for applying pressure to the ink 9, and are arranged side by side so as to be parallel to each other at predetermined intervals. Each of the channels is partitioned with drive walls (not shown) formed of a piezoelectric body, and forms a groove section having a recessed shape in a cross-sectional view.

In such channels, there exist ejection channels for ejecting the ink 9, and dummy channels (non-ejection channels) which do not eject the ink 9. In other words, it is arranged that the ejection channels are filled with the ink 9 on the one hand, but the dummy channels are not filled with the ink 9 on the other hand. It should be noted that it is arranged that filling of each of the ejection channels with the ink 9 is performed via, for example, a flow channel (a common flow channel) commonly communicated with such ejection channels. Further, it is arranged that each of the ejection channels is individually communicated with the nozzle hole Hn in the nozzle plate 112 on the one hand, but each of the dummy channels is not communicated with the nozzle hole Hn on the other hand. These ejection channels and the dummy channels are alternately arranged side by side along the column direction (the X-axis direction) described above.

Further, on the inner side surfaces opposed to each other in the drive wall described above, there are respectively disposed drive electrodes. As the drive electrodes, there exist common electrodes disposed on the inner side surfaces facing the ejection channels, and active electrodes (individual electrodes) disposed on the inner side surfaces facing the dummy channels. These drive electrodes and the drive devices 41 described later are electrically coupled to each other via each of the flexible boards 13a, 13b, 13c, and 13d. Thus, it is arranged that the drive voltages Vd (the drive signals Sd) described above are applied to the drive electrodes from the drive devices 41 via each of the flexible boards 13a, 13b, 13c, and 13d (see FIG. 1).

### (C-3. Flexible Boards 13a, 13b, 13c, and 13d)

The flexible boards 13a, 13b, 13c, and 13d are each a board for electrically coupling the I/F board 12 and the jet section 11 to each other as shown in FIG. 2 and FIG. 3. It is arranged that these flexible boards 13a, 13b, 13c, and 13d individually control the jet actions of the ink 9 in the four nozzle arrays in the nozzle plate 112 described above, respectively. Further, as indicated by, for example, the reference symbols P1a, P1b, P1c, and P1d in FIG. 3, it is arranged that the flexible boards 13a, 13b, 13c, and 13d are folded around places (around clamping electrodes 433) where the flexible boards 13a, 13b, 13c, and 13d are coupled to the jet section 11, respectively. It should be noted that it is arranged that electrical coupling between the clamping electrodes 433 and the jet section 11 is achieved by, for example, thermocompression bonding using an ACF (Anisotropic Conductive Film).

On each of such flexible boards 13a, 13b, 13c, and 13d, there is individually mounted a single drive device 41 or a plurality of drive devices 41 (see FIG. 3). These drive devices 41 are each a device for outputting the drive signals Sd (the drive voltages Vd) for jetting the ink 9 from the nozzle holes Hn in the corresponding nozzle array in the jet section 11. It should be noted that this drive signal Sd has a predetermined drive waveform although the details will be described later. Therefore, it is arranged that such drive signals Sd are output from each of the flexible boards 13a, 13b, 13c, and 13d to the jet section 11. It should be noted that such drive devices 41 are each formed of, for example, an ASIC (Application Specific Integrated Circuit).

Further, these drive devices 41 are arranged to be cooled by the cooling units 141, 142 described above. Specifically, as shown in FIG. 3, the cooling unit 141 is fixedly disposed between the drive devices 41 on the flexible boards 13a, 13b, and by pressing the cooling unit 141 against these drive devices 41, the drive devices 41 are cooled. Similarly, the cooling unit 142 is fixedly disposed between the drive devices 41 on the flexible boards 13c, 13d, and by pressing the cooling unit 142 against these drive devices 41, the drive devices 41 are cooled. It should be noted that such cooling units 141, 142 can each be configured using a variety of types of cooling mechanisms.

### [Detailed Configuration of Inkjet Head 1]

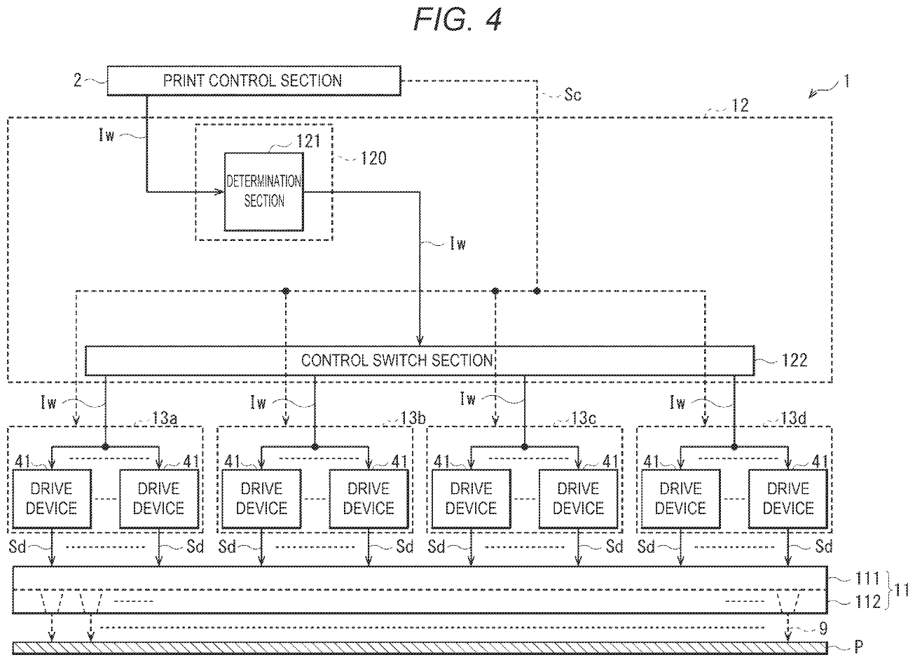

Then, the detailed configuration example of the inkjet head 1 will be described with reference to FIG. 4 in addition to FIG. 1 through FIG. 3.

FIG. 4 is a block diagram showing a detailed configuration example of the inkjet head 1 shown in FIG. 1 through FIG. 3. As shown in FIG. 4, the inkjet head 1 is provided with the I/F board 12, the flexible boards 13a through 13d, and the jet section 11 described above. Further, the I/F board 12 has a control device 120 including a determination section 121, and a control switch section 122, wherein the flexible boards 13a through 13d each have the plurality of drive devices 41. It should be noted that the plurality of drive devices 41 in each of the flexible boards 13a through 13d is arranged to be, for example, coupled in series (cascaded) to each other.

### (Determination Section 121)

The determination section 121 is for performing a determination on whether or not the drive signal Sd based on the waveform configuration information Iw supplied from the outside (the print control section 2) of the inkjet head 1 should be output from each of the drive devices 41 described above to the jet section 11. Specifically, in the present embodiment, the determination section 121 determines whether or not a predetermined abnormal waveform configuration described later is included in the waveform configuration information Iw. Further, the determination section 121 is arranged to perform the determination that the drive signal Sd should not be output from each of the drive devices 41 when the determination section 121 determines that such abnormal waveform configuration is included in the waveform configuration information Iw.

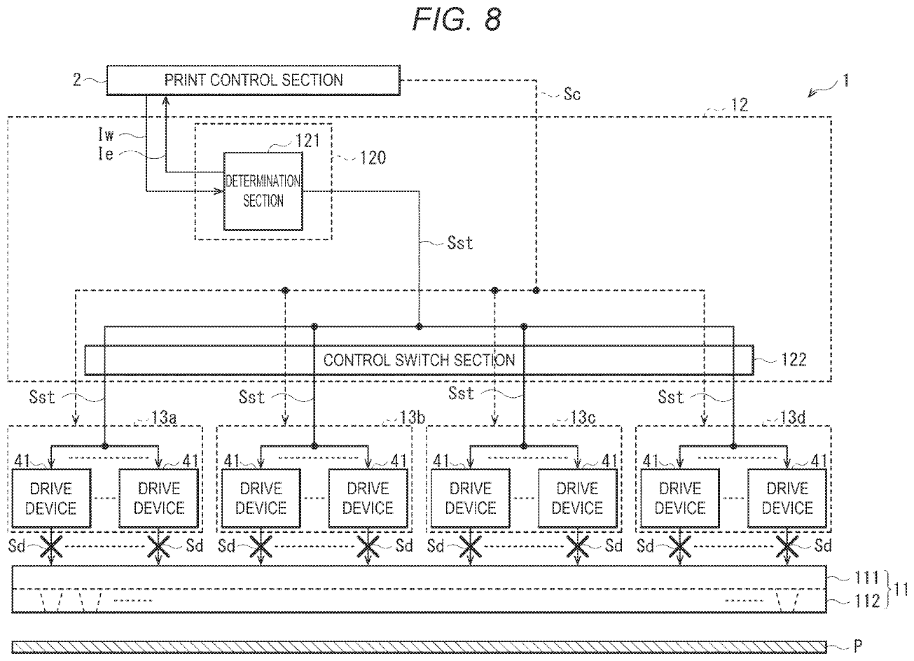

When such a determination section 121 has determined that the drive signal Sd should not be output from each of the drive devices 41 as described above, the determination section 121 performs the following operations. That is, although the details will be described later, in this case, the determination section 121 outputs (see FIG. 8) an ejection stop signal Sst for stopping the jet of the ink 9 from the jet section 11 to each of the drive devices 41. Further, although the details will be described later, in this case, the determination section 121 is arranged to output error information Ie to the outside (the print control section 2) of the inkjet head 1 to thereby give an error notification (see FIG. 8).

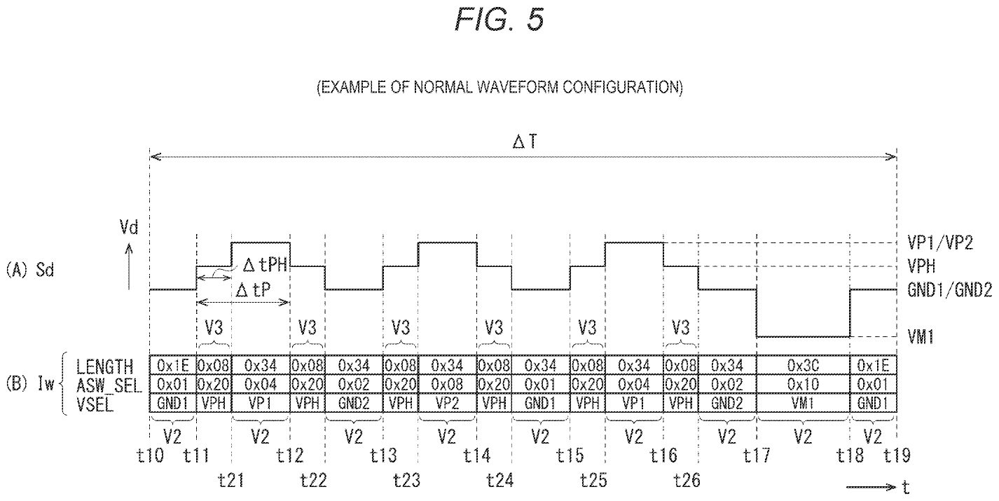

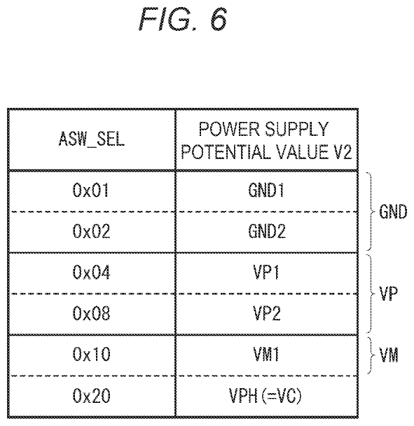

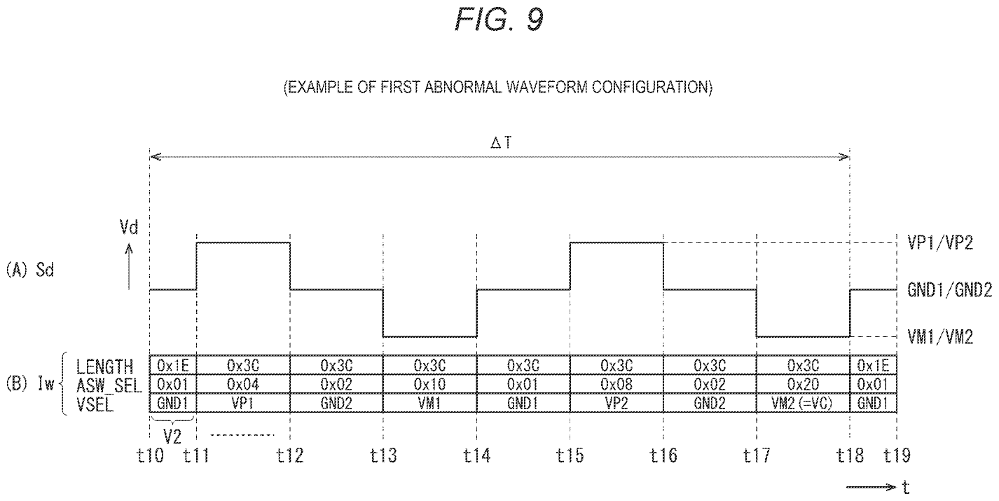

It should be noted that the details of the waveform configuration information Iw described above will be described later (see FIG. 5 and FIG. 6). Further, the details of the determination operation described above by the determination section 121 will also be described later (see FIG. 9 through FIG. 11).

### (Control Switch Section 122)

As shown in FIG. 4, the control switch section 122 is disposed between determination section 121 and the plurality of flexible boards 13a through 13d. The control switch section 122 is arranged to perform a predetermined control switch action when transmitting the waveform configuration information Iw and so on transmitted from the determination section 121, to each of the drive devices 41 in the plurality of flexible boards 13a through 13d. Specifically, the control switch section 122 performs the control switch action between a transmission control action and a blocking control action described below.

When performing the transmission control action, it is arranged that the waveform configuration information Iw is transmitted to the drive devices 41 in at least one of the flexible boards 13a through 13d in parallel to each other. In contrast, it is arranged that the transmission of the waveform configuration information Iw to each of the drive devices 41 in all of the flexible boards 13a through 13d is blocked when performing the blocking control action.

### [Configuration of Waveform Configuration Information]

Then, a configuration (a data configuration example) of the waveform configuration information Iw described above will be described with reference to FIG. 5 and FIG. 6 in addition to FIG. 4.

FIG. 5 is a timing chart showing a configuration example and so on (an example of a normal waveform configuration) of the waveform configuration information Iw. Specifically, in FIG. 5(B), there is shown a data configuration example of the waveform configuration information Iw, and in FIG. 5(A), there is shown a waveform example of the drive signal Sd set using the waveform configuration information Iw. It should be noted that the horizontal axis in FIG. 5 represents time t. Further, FIG. 6 is a diagram schematically showing the detailed configuration example of a power supply potential value V2 described later and shown in FIG. 5(B).

The waveform configuration information Iw includes a plurality of types of power supply potential values V2, and information (intermediate potential value information V3) representing VPH as an intermediate potential value. Specifically, as shown in FIG. 5(B), the waveform configuration information Iw has ASW_SEL as power supply selection information, VSEL as power supply potential value information, and LENGTH as power supply potential period information for each of the power supply potential values V2 and each of the periods of the intermediate potential value information V3.

Particularly, in the example shown in FIG. 5(B), first, ASW_SEL, VSEL, and LENGTH are set for each of the periods between the timings t10 and t11, the timings t11 and t12, the timings t12 and t13, the timings t13 and t14, the timings t14 and t15, the timings t15 and t16, the timings t16 and t17, the timings t17 and t18, and the timings t18 and t19. Further, in the example shown in FIG. 5(B), the intermediate potential value information V3 described above is additionally set between the power supply potential values V2 along the time axis in each of a period between the timings t11 and t12 (the timing t11 to timing t21), a period between the timings t12 and t13 (the timing t12 to timing t22), a period between the timings t13 and t14 (the timing t13 to timing t23), a period between the timings t14 and t15 (the timing t14 to timing t24), a period between the timings t15 and t16 (the timing t15 to timing t25), and a period between the timings t16 and t17 (the timing t16 to timing t26).

The ASW_SEL described above is information for selecting one type of power supply potential value V2 from the plurality of types of power supply potential values V2. Specifically, in the example shown in FIG. 5(B) and FIG. 6, ASW_SEL is expressed by a hexadecimal value (2 bits), and the correspondence relationships with six types of power supply potential values V2 are set as follows. In other words, it is arranged that (GND1/GND2), (VP1/VP2), and VM1 are set individually, in accordance with each of GND (a ground potential value as a predetermined reference potential value), VP (a predetermined positive potential value), and VM (a predetermined negative potential value) shown in, for example, FIG. 6 (see FIG. 6). Further, as described below, in the example shown in FIG. 6, it is arranged that VPH (=VC) as the intermediate potential value described above is set when ASW_SEL=0x20 is true.
ASW_SEL=0x01→V2=GND1 (a first ground potential value)
ASW_SEL=0x02→V2=GND2 (a second ground potential value)
ASW_SEL=0x 04→V2=VP1 (a first positive potential value)
ASW_SEL=0x 08→V2=VP2 (a second positive potential value)
ASW_SEL=0x10→V2=VM1 (a first negative potential value)
ASW_SEL=0x20→V2=VPH (=VC) (an intermediate potential value)

VSEL described above is obtained by setting one type of power supply potential value V2 which is selected by ASW_SEL along the time axis (see FIG. 5(B)).

LENGTH described above represents a period for the one type of power supply potential value V2 in VSEL, and is represented by the number of internal clock pluses (2 bits of a hexadecimal value) used in the drive devices 41 in the example shown in FIG. 5(B). Specifically, for example, when (internal clock period)=50 [ns] is true, the period of 50 [ns]×16=800 [ns] is obtained when LENGTH1=0x10 is true, the period of 50 [ns]×30=1.5 [μs] is obtained when LENGTH1=0x1E is true, and the period of 50 [ns]×60=3.0 [μs] is obtained when LENGTH1=0x3C is true.

Here, VPH (VSEL=VPH) as the intermediate potential value described above is a potential value located between a ground potential value (GND1/GND2) as the reference potential value and a positive potential value (VP1/VP2) out of the power supply potential values V2 to be set in the drive waveform of the drive signal Sd. Further, in the example shown in FIG. 5(B), such VPH is set to VPH=(the positive potential value (VP1/VP2))×0.5. It should be noted that the value of VPH is not limited to this example ((the positive potential value)×0.5), and it is sufficient for the value of VPH to be a potential value located between the reference potential value (the ground potential value GND) and the positive potential value VP.

Further, such VPH is set only for a short period of time in a rising stage or a falling stage when setting such a stepwise drive waveform (a rising edge and a falling edge of the waveform in the drive signal Sd) as shown in FIG. 5(A). Specifically, although the details will be described later, it is desirable to step at VPH in such a rising stage and such a falling stage (in the transition between the reference potential value and the positive potential value described above). Thus, it becomes possible to reduce the power consumption (the drive current to the jet section 11 as a load capacity) when setting such a stepwise drive waveform.

Here, in the example shown in FIG. 6, at least some of the power supply potential values V2 (the ground potential value GND, the positive potential value VP, and the negative potential value VM) include a plurality of types (the two types in this example) of the power supply potential values V2 corresponding to supply values from power supply lines different from each other. In other words, as described above, the two types of ground potential values (GND1/GND2) and the two types of positive potential values (VP1/VP2) are respectively included. In such a manner as described above, in the example shown in FIG. 5(B), the plurality of types (two types) of power supply potential values V2 are set so as to take turns in a predetermined order (two types of power supply potential values V2 alternately take turns in this example) in a predetermined unit period ΔT.

Although the details will be described later, the reason therefor is to apparently increase an allowable consumption current value per unit period ΔT in each of the power supply lines. Specifically, for example, when there are disposed two power supply lines the same in potential and each having the allowable consumption current value equal to 300 [mA], the allowable consumption current value as a whole can be assumed up to 600 [mA] when alternately selecting these two power supply lines to set the drive waveform. Further, besides when alternately selecting them in such a manner, it is possible to apparently increase the allowable consumption current in substantially the same manner when, for example, these two power supply lines are the same in use frequency (frequency of setting) in the unit period ΔT.

It can be said that it is desirable for the power supply potential values V2 the same in type to be set so as to be used a smaller number of times than a predetermined number (e.g., twice or three times) within the unit period ΔT in such a manner. The reason is that, although the details will be described later, thus, the breakage and so on of the inkjet head 1 due to the fact that the allowable current consumption value per unit period ΔT in the power supply line is exceeded is prevented.

Here, the flexible boards 13a through 13d described above each correspond to a specific example of a “drive board” in the present disclosure. Further, VSEL described above corresponds to a specific example of the “power supply potential value information” in the present disclosure, and the ground potential values GND (GND1, GND2) described above each correspond to a specific example of the “reference potential value” in the present disclosure. Further, the positive potential values VP (VP1, VP2) described above each correspond to a specific example of the “positive potential value” in the present disclosure, and the negative potential values VM (VM1) described above each correspond to the “negative potential value” in the present disclosure. Further, VPH described above corresponds to a specific example of the “intermediate potential value” in the present disclosure.

### [Operations and Functions/Advantages]

### (A. Basic Operation of Printer 5)

In the printer 5, a recording operation (a printing operation) of images, characters, and so on to the recording target medium (the recording paper P and so on) is performed using such a jet operation of the ink 9 by the inkjet head 1 as described below. Specifically, in the inkjet head 1 according to the present embodiment, the jet operation of the ink 9 using a shear mode is performed in the following manner.

First, the drive devices 41 on each of the flexible boards 13a, 13b, 13c, and 13d each apply the drive voltage Vd (the drive signal Sd) to the drive electrodes (the common electrode and the active electrode) described above in the actuator plate 111 in the jet section 11. Specifically, each of the drive devices 41 applies the drive voltage Vd to the drive electrodes disposed on the pair of drive walls partitioning the ejection channel described above. Thus, the pair of drive walls each deform so as to protrude toward the dummy channel adjacent to the ejection channel.

On this occasion, it results in that the drive wall makes a flexion deformation to have a V shape centering on the intermediate position in the depth direction in the drive wall. Further, due to such a flexion deformation of the drive wall, the ejection channel deforms as if the ejection channel bulges. As described above, due to the flexion deformation caused by a piezoelectric thickness-shear effect in the pair of drive walls, the volume of the ejection channel increases. Further, by the volume of the ejection channel increasing, the ink 9 is induced into the ejection channel as a result.

Subsequently, the ink 9 having been induced into the ejection channel in such a manner turns to a pressure wave to propagate to the inside of the ejection channel. Then, the drive voltage Vd to be applied to the drive electrodes becomes 0 (zero) V at the timing at which the pressure wave has reached the nozzle hole Hn of the nozzle plate 112 (or timing in the vicinity of that timing). Thus, the drive walls are restored from the state of the flexion deformation described above, and as a result, the volume of the ejection channel having once increased is restored again.

In such a manner, the pressure in the ejection channel increases in the process that the volume of the ejection channel is restored, and thus, the ink 9 in the ejection channel is pressurized. As a result, the ink 9 having shaped like a droplet is ejected (see FIG. 1, FIG. 2, and FIG. 4) toward the outside (toward the recording paper P) through the nozzle hole Hn. The jet operation (the ejection operation) of the ink 9 in the inkjet head 1 is performed in such a manner, and as a result, the recording operation of images, characters, and so on to the recording paper P is performed.

### (B. Detailed Operations and Functions/Advantages)

Then, the detailed operations, functions, and advantages in the inkjet head 1 according to the present embodiment will be described in comparison with a related-art method.

### (B-1. Related Art Method)

First, in recent years, complication of the drive waveform progresses in the drive signal for driving the jet section in the inkjet head. Such a complicated waveform is used aiming at a variety of effects such as a reduction in drive noise generated when performing ejection, a correction of a variation in ejection performance, or an improvement in print quality. Specifically, for example, in Patent Literature 1 described above, a correction in voltage is performed on a common drive waveform for driving the nozzles in order to suppress a variation in ejection volume of the nozzles.

However, such a method is effective for the drive of the inkjet head on the one hand, but the setting of the drive waveform itself becomes further complicated on the other hand. Further, such a complicated drive waveform is capable of exerting the on-target effect in the state in which the drive waveform is set correctly on the one hand, but assuming that the drive waveform is faultily set, there is a possibility that the on-target effect cannot be obtained, and moreover, a false operation, a malfunction, a breakage, and so on of the inkjet head are induced.

Further, for example, there can be cited a method in which it is arranged that a retrieving function of retrieving the drive waveform is disposed in the inkjet head, and by comparing the drive waveform actually set to the inkjet head and the drive waveform which should originally be set to the inkjet head with each other, an error in the drive waveform setting is detected and then corrected. It should be noted that in this method, the comparison between the transmission data and the reception data related to the waveform setting is merely performed, and therefore, when the transmission data itself is wrong, no effect is obtained as a result.

In such a manner, in the related-art method, it can be said that there is a possibility that the reliability of the inkjet head degrades.

### (B-2. Determination Operation etc.)

Therefore, in the inkjet head 1 according to the present embodiment, it is arranged that such a variety of operations (the determination operation and so on by the determination section 121) as described below are performed.

Specifically, first, as described above, the determination section 121 makes a determination on whether or not the drive signal Sd based on the waveform configuration information Iw supplied from the outside (the print control section 2) of the inkjet head 1 should be output from each of the drive devices 41 to the jet section 11.

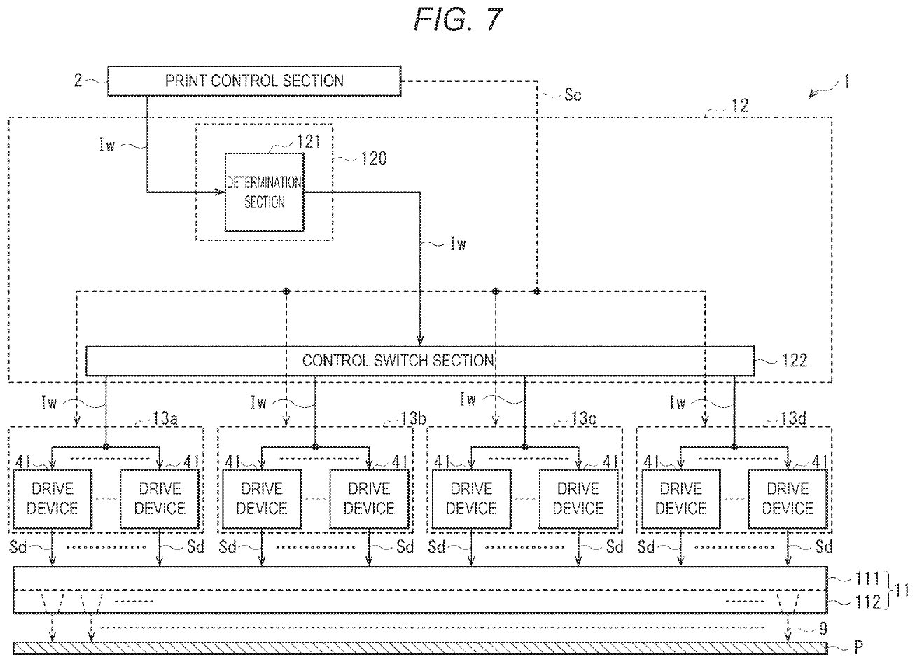

Further, in accordance with the determination result, the operations shown in, for example, FIG. 7 and FIG. 8 are performed. These FIG. 7 and FIG. 8 are each a block diagram showing an operation example (an example of the operations corresponding to the determination result in the determination section 121) in the inkjet head 1.

First, in the determination section 121, when it is determined that the drive signal Sd should be output, the operation shown in, for example, FIG. 7 is performed. In other words, in this case, first, using the transmission control operation by the control switch section 122 described above, the waveform configuration information Iw is transmitted in parallel from the determination section 121 to the drive devices 41 in at least one of the flexible boards 13a through 13d via the control switch section 122. Further, it results in that based on the waveform configuration information Iw transmitted in such a manner, the drive signal Sd is output from the drive devices 41 to the jet section 11, and the jet operation of the ink 9 described above from the jet section 11 is performed.

In contrast, in the determination section 121, when it is determined that the drive signal Sd should not be output, the operation shown in, for example, FIG. 8 is performed. In other words, in this case, first, the ejection stop signal Sst is transmitted from the determination section 121 to the drive devices 41 in at least one of the flexible boards 13a through 13d in parallel to each other. Further, it results in that based on the ejection stop signal Sst transmitted in such a manner, the output of the drive signal Sd to the jet section 11 from each of the drive devices 41 is stopped (see “×(cross)” marks shown in FIG. 8), and the jet operation of the ink 9 from the jet section 11 is stopped. Further, as shown in FIG. 8, on this occasion, the determination section 121 outputs error information Ie to the outside (the print control section 2) of the inkjet head 1 to thereby give an error notification. It should be noted that although in the example shown in FIG. 8, there is shown the case in which the ejection stop signal Sst is transmitted to each of the drive devices 41 without the intervention of the control switch section 122, the example of this case is not a limitation. Specifically, it is possible to arrange that the ejection stop signal Sst is transmitted to each of the drive devices 41 via the control switch section 122 in substantially the same manner as, for example, the case of the waveform configuration information Iw shown in FIG. 7. Further, regarding the output operation of such an ejection stop signal Sst and the error information Ie when it has been determined that the drive signal Sd should not be output, the same also applied to each of modified examples (Modified Example 1 through Modified Example 6) described later.

Further, in the present embodiment, when a predetermined abnormal waveform configuration is included in the waveform configuration information Iw, the determination section 121 makes the determination that the drive signal Sd should not be output from the drive device 41 as described above.

Here, FIG. 9 through FIG. 11 are timing charts showing examples of first through third abnormal waveform configurations, respectively. It should be noted that the examples shown in FIG. 9 through FIG. 11 described above each correspond to what is obtained by changing a part of the configuration in the configuration example (the example of the normal waveform configuration) of the waveform configuration information Iw shown in FIG. 5 described above.

First, in the example of the first abnormal waveform configuration shown in FIG. 9, there is provided the waveform configuration in which the drive signal Sd does not step at the intermediate potential value (VPH) in the transition (the rising transition or the falling transition) between the ground potential value (GND1/GND2) as the reference potential value described above and the positive potential value (VP1/VP2). Specifically, in the example of the first abnormal waveform configuration, unlike the case of the normal waveform configuration shown in FIG. 5, in the rising transition from the ground potential value (GND1/GND2) to the positive potential value (VP1/VP2), the drive signal Sd makes the direct transition to the positive potential value (VP1/VP2) without stepping at the intermediate potential value (VPH). Similarly, unlike the case of the normal waveform configuration shown in FIG. 5, in the falling transition from the positive potential value (VP1/VP2) to the ground potential value (GND1/GND2), the drive signal Sd also makes the direct transition to the ground potential value (GND1/GND2) without stepping at the intermediate potential value (VPH).

Further, when such a first abnormal waveform configuration is included in VSEL (the power supply potential value information) described above in the waveform configuration information Iw, the determination section 121 makes the determination that the drive signal Sd should not be output.

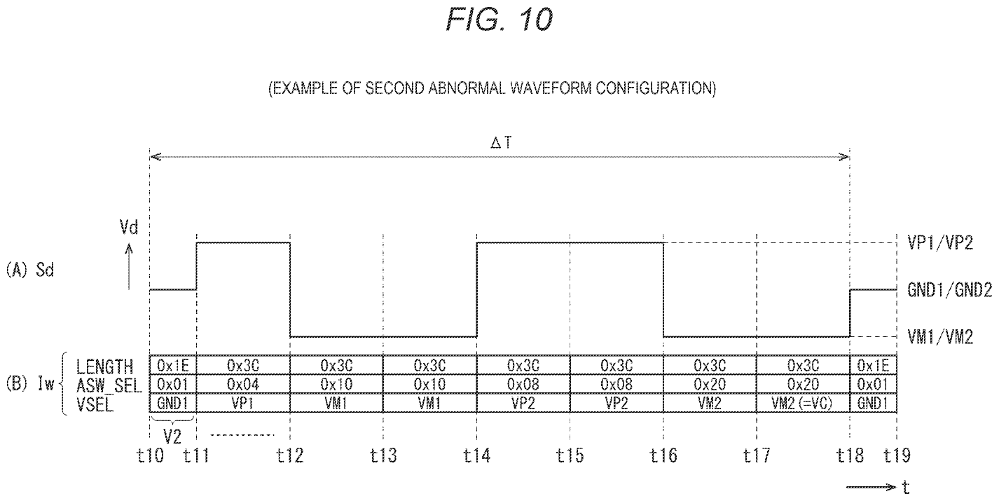

Further, in the example of the second abnormal waveform configuration shown in FIG. 10, there is provided the waveform configuration in which the drive signal Sd does not step at the ground potential value (GND1/GND2) in the transition (the rising transition or the falling transition) between the negative potential value (VM1/VM2 (=VC)) described above and the positive potential value (VP1/VP2). Specifically, in the example of the second abnormal waveform configuration, unlike the case of the normal waveform configuration shown in FIG. 5, in the rising transition from the negative potential value (VM1/VM2) to the positive potential value (VP1/VP2), the drive signal Sd makes the direct transition to the positive potential value (VP1/VP2) without stepping at the ground potential value (GND1/GND2). Similarly, unlike the case of the normal waveform configuration shown in FIG. 5, in the falling transition from the positive potential value (VP1/VP2) to the negative potential value (VM1/VM2), the drive signal Sd also makes the direct transition to the negative potential value (VM1/VM2) without stepping at the ground potential value (GND1/GND2).

Further, when such a second abnormal waveform configuration is included in VSEL (the power supply potential value information) in the waveform configuration information Iw, the determination section 121 makes the determination that the drive signal Sd should not be output.

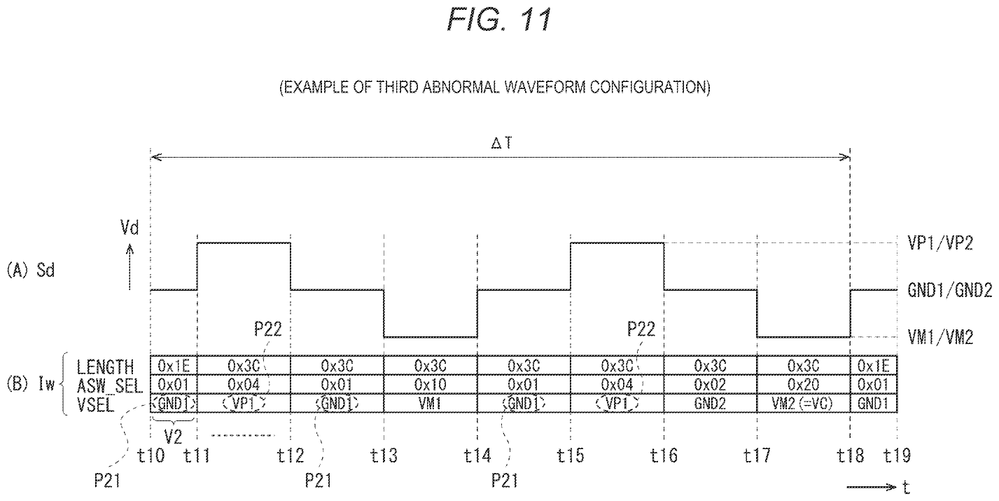

Further, in the example of the third abnormal waveform configuration shown in FIG. 11, there is provided the configuration in which the power supply potential value V2 of the same type is used a number of times equal to or larger than a predetermined number of times (e.g., twice or three times) in the unit period of time ΔT. Specifically, in the example of the third abnormal waveform configuration, unlike the case of the normal waveform configuration shown in FIG. 5, there is provided the configuration in which the power supply potential value V2 (=GND1) of the same type is used three times (in a row) in the unit period of time ΔT (see the reference symbols P21 in FIG. 11). Further, in the example of the third abnormal waveform configuration, unlike the case of the normal waveform configuration shown in FIG. 5, there is provided the configuration in which the power supply potential value V2 (=VP1) of the same type is used twice (in a row) in the unit period of time ΔT (see the reference symbols P22 in FIG. 11).

Further, when such a third abnormal waveform configuration is included in VSEL (the power supply potential value information) in the waveform configuration information Iw, the determination section 121 makes the determination that the drive signal Sd should not be output.

It should be noted that as the predetermined abnormal waveform configuration described above, there can be cited, for example, the following waveform configuration besides the first through third abnormal waveform configurations described above.

That is, first, there can be cited when, for example, the length of the setting period (see a period ΔtPH shown in FIG. 5(A)) of the intermediate potential value (VPH) described above becomes longer than the length of the setting period (see a period ΔtP shown in FIG. 5(B)) of original before the additional setting of this VPH (VP1/VP2) or original (GND1/GND2) (ΔtPH≥ΔtP). This is because when (ΔtPH≥ΔtP) is realized, the period of (VP1/VP2) or (GND1/GND2) disappears when adding the setting period of VPH, and it results in an inappropriate drive waveform. It should be noted that it is possible to arrange that the abnormal waveform configuration is determined when the value of LENGTH in this period ΔtPH becomes, for example, no more than 0x03, or no less than 0x09.

Further, it is possible to arrange that the abnormal waveform configuration is determined when, for example, the power supply potential value V2 other than GND (GND1/GND2) is set at the beginning and the ending along the time axis in the waveform configuration. This is for preventing an unintended selection of the drive power. Specifically, this is because, for example, when V2=VP1 is set at the ending of the first waveform, and V2=VM is set at the beginning of the second waveform, a voltage change from VP1 to VM occurs to increase the power consumption when these two waveforms are contiguously output.

### (B-3. Functions/Advantages)

In such a manner, in the present embodiment, since it is arranged that the determination on whether or not the drive signal Sd based on the waveform configuration information Iw should be output from the drive devices 41 to the jet section 11 is made in the determination section 121, the following is achieved. That is, even when, for example, the user of the inkjet head 1 performs an erroneous setting (a setting of the waveform configuration information Iw and so on), there is made the determination on whether or not the drive signal Sd should be output to the jet section 11 (whether or not jetting of the ink 9 from the jet section 11 should be executed), and therefore, it is possible to take a variety of countermeasures against the false operation, the breakage, and so on of the inkjet head 1. As a result, in the present embodiment, it becomes possible to achieve an increase in reliability of the inkjet head 1.

Specifically, in the present embodiment, when it is determined that the drive signal Sd should not be output, the ejection stop signal Sst is output to the drive devices 41, and at the same time, the error information Ie is output to the outside (the print control section 2) of the inkjet head 1 to thereby perform the error notification, and therefore, the following is achieved. That is, since the jetting of the ink 9 from the jet section 11 is stopped, it is possible to actually prevent the false operation, the breakage, and so on of the inkjet head 1, and thus, it becomes possible to further increase the reliability of the inkjet head 1. Further, it is possible for the user to figure out the error notification described above, and it becomes possible to increase the convenience.

Further, in the present embodiment, since the determination that the drive signal Sd should not be output is made when the predetermined abnormal waveform configuration is included in the waveform configuration information Iw, the following is achieved. That is, it is possible to take a variety of countermeasures against the false operation, the breakage, and so on of the inkjet head 1 caused by the drive signals Sd generated using such an abnormal waveform configuration. As a result, it becomes possible to prevent the deterioration of the reliability of the inkjet head 1 caused by such drive signals Sd to thereby achieve an increase in reliability.

Further, in the present embodiment, since the determination that the drive signals Sd should not be output is made when the first abnormal waveform configuration (see FIG. 9) described above is included in VSEL (the power supply potential value information) in the waveform configuration information Iw as the predetermined abnormal waveform configuration described above, the following is achieved. That is, for example, when setting the stepwise drive waveform (the drive waveform in the transition between the ground potential value (GND) as the reference potential value described above and the positive potential value (VP)), it is possible to take a countermeasure against the increase in power consumption caused by the increase in drive current in the power supply at the positive potential value to thereby achieve the electrical power saving. As a result, it becomes possible to achieve the increase in reliability in the inkjet head 1.

In addition, in the present embodiment, since the determination that the drive signals Sd should not be output is made when the second abnormal waveform configuration (see FIG. 10) described above is included in VSEL in the waveform configuration information Iw as the predetermined abnormal waveform configuration described above, the following is achieved. That is, for example, when setting the stepwise drive waveform (the drive waveform in the transition between the negative potential value (VM) described above and the positive potential value (VP)), it is possible to take a variety of countermeasures against the breakage of the inkjet head 1 due to the heat generation in the drive devices 41 caused by the occurrence of a wasted drive current in the power supply at the negative potential value. As a result, it becomes possible to prevent the deterioration of the reliability of the inkjet head 1 caused by such breakage of the inkjet head 1 and so on to thereby achieve an increase in reliability.

Further, in the present embodiment, since the determination that the drive signals Sd should not be output is made when the third abnormal waveform configuration (see FIG. 11) described above is included in VSEL in the waveform configuration information Iw as the predetermined abnormal waveform configuration described above, the following is achieved. That is, as described above, it is possible to take a variety of countermeasures against the breakage of the inkjet head 1 and so on caused by the fact that the allowable current consumption value per unit period of time ΔT in the power supply line is exceeded when there is adopted the configuration in which the power supply potential value of the same type is used a number of times equal to or larger than a predetermined number of times within the unit period of time ΔT. As a result, it becomes possible to prevent the deterioration of the reliability of the inkjet head 1 caused by such breakage of the inkjet head 1 and so on to thereby achieve an increase in reliability.

Further, in the present embodiment, since it is arranged that the waveform configuration information Iw is transmitted (see FIG. 7) to the drive devices 41 in each of the flexible boards 13a through 13d via the control switch section 122 in parallel to each other, the following is achieved. That is, it becomes possible to reduce the time (setting time) required for the setting of the drive waveform into up to about ¼ compared to when, for example, the waveform configuration information Iw is sequentially transmitted to the drive devices 41 in each of the flexible boards 13a through 13d.

### 2. MODIFIED EXAMPLES

Then, some modified examples (Modified Example 1 through Modified Example 6) of the embodiment described above will be described. It should be noted that hereinafter, the same constituents as those in the embodiment are denoted by the same reference symbols, and the description thereof will arbitrarily be omitted.

### Modified Example 1 through Modified Example 3

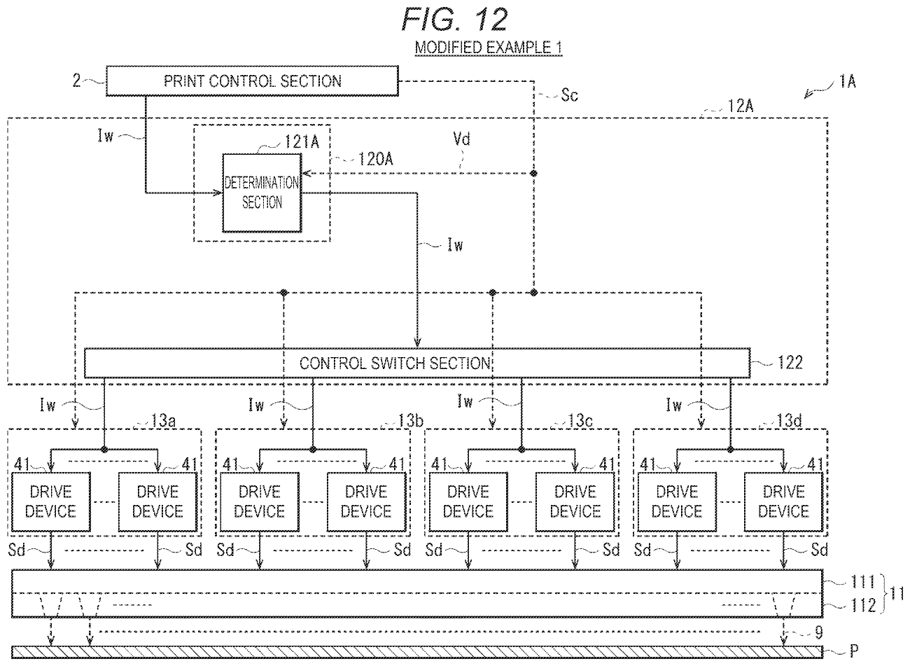

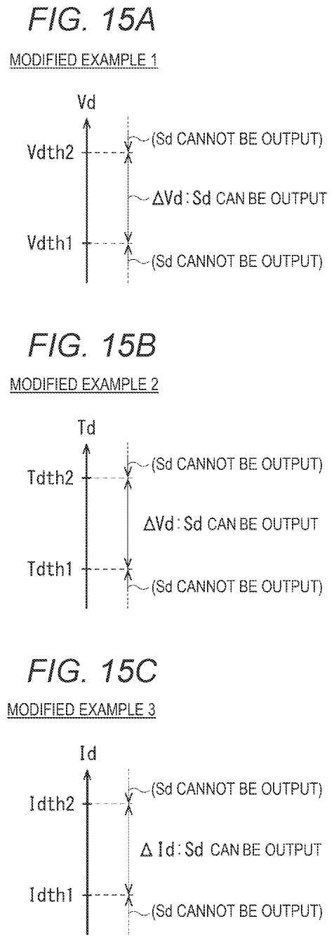

FIG. 12 through FIG. 14 are block diagrams showing configuration examples of liquid jet heads (inkjet heads 1A through 1C) according to Modified Example 1 through Modified Example 3, respectively. Further, FIG. 15A through FIG. 15C schematically show examples of the correspondence relationships related to Modified Example 1 through Modified Example 3, respectively. Specifically, FIG. 15A shows an example of the correspondence relationship (a correspondence relationship between a range of the drive voltage Vd and an operation) related to Modified Example 1. Further, FIG. 15B shows an example of the correspondence relationship (a correspondence relationship between a range of device temperature Td described later and an operation) related to Modified Example 2. Further, FIG. 15C shows an example of the correspondence relationship (a correspondence relationship between a range of a drive current Id described later and an operation) related to Modified Example 3.

### (Configuration of Modified Examples 1)

First, an inkjet head 1A according to Modified Example 1 shown in FIG. 12 corresponds to what is provided with an I/F board 12A instead of the I/F board 12 in the inkjet head 1 (see FIG. 4) according to the embodiment. Further, the I/F board 12A corresponds to what is provided with a control device 120A including a determination section 121A described below instead of the control device 120 including the determination section 121 in the I/F board 12.

It should be noted that the inkjet head 1A corresponds to a specific example of the “liquid jet head” in the present disclosure. Further, a printer equipped with the inkjet head 1A corresponds to a specific example of the “liquid jet recording device” in the present disclosure.

As shown in FIG. 12, the determination section 121A described above obtains information of the drive voltages Vd included in the print control signal Sc. Then, the determination section 121A makes a determination on whether or not the drive voltage Vd is a value within a predetermined voltage range ΔVd (see FIG. 15A). It should be noted that the voltage range ΔVd is a voltage range which fulfills ((a threshold voltage (a lower limit value)) Vdth1)≤Vd≤((a threshold voltage (an upper limit value)) Vdth2) as shown in, for example, FIG. 15A.

Here, when the drive voltage Vd is within the voltage range ΔVd (Vdth1≤Vd≤Vdth2), the determination section 121A makes the determination that the drive signal Sd should be output. In contrast, when the drive voltage Vd is out of the voltage range ΔVd (Vdth1>Vd, or Vd>Vdth2), the determination section 121A makes the determination that the drive signal Sd should not be output.

It should be noted that as a detailed example of the voltage range ΔVd in the drive voltage Vd described above, there can be cited, for example, the following.

20V≤(CPI−VM)≤50V

10V≤VPI≤26V

−26V≤VM≤−10V

### (Configuration of Modified Examples 2)

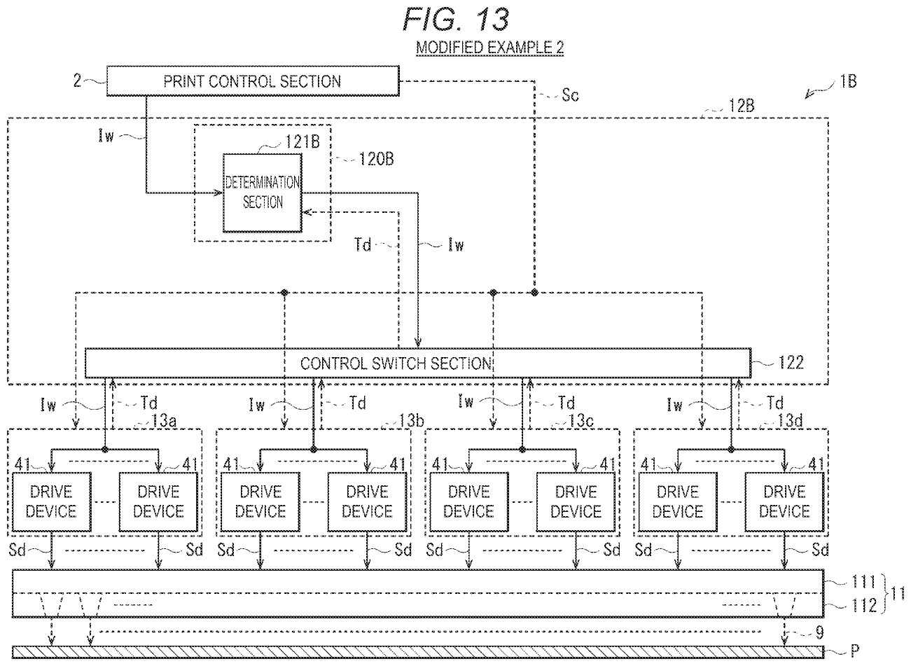

Further, an inkjet head 1B according to Modified Example 2 shown in FIG. 13 corresponds to what is provided with an I/F board 12B instead of the I/F board 12 in the inkjet head 1 (see FIG. 4) according to the embodiment. Further, the I/F board 12B corresponds to what is provided with a control device 120B including a determination section 121B described below instead of the control device 120 including the determination section 121 in the I/F board 12.

It should be noted that the inkjet head 1B corresponds to a specific example of the “liquid jet head” in the present disclosure. Further, a printer equipped with the inkjet head 1B corresponds to a specific example of the “liquid jet recording device” in the present disclosure.

As shown in FIG. 13, the determination section 121B obtains the information of the device temperature Td in the drive devices 41 from the drive devices 41 in the plurality of flexible boards 13a through 13d. Then, the determination section 121B makes a determination on whether or not the device temperature Td is a value within a predetermined temperature range ΔVd (see FIG. 15B). It should be noted that the temperature range ΔTd is a temperature range which fulfills ((a threshold temperature (a lower limit value)) Tdth1)≤Td≤((a threshold temperature (an upper limit value)) Tdth2) as shown in, for example, FIG. 15B.

Here, when the device temperature Td is within the temperature range ΔTd (Tdth1≤Td≤Tdth2), the determination section 121B makes the determination that the drive signal Sd should be output. In contrast, when the device temperature Td is out of the temperature range ΔTd (Tdth1>Td, or Td>Tdth2), the determination section 121B makes the determination that the drive signal Sd should not be output.

Incidentally, as a cause that the device temperature Td of the drive device 41 itself rises, there is assumed a state in which, for example, the cooling unit 141 (a metal plate or the like) described above for cooling the drive devices 41 is separated due to a vibration, and the cooling performance is not exerted. Further, as the cause, it is also assumed that, for example, the rise in temperature of the drive device 41 exceeds the cooling performance of the cooling unit 141 when the user uses the inkjet head 1B against the recommended operating conditions for assuring the performance of the inkjet head 1B.

### (Configuration of Modified Examples 3)

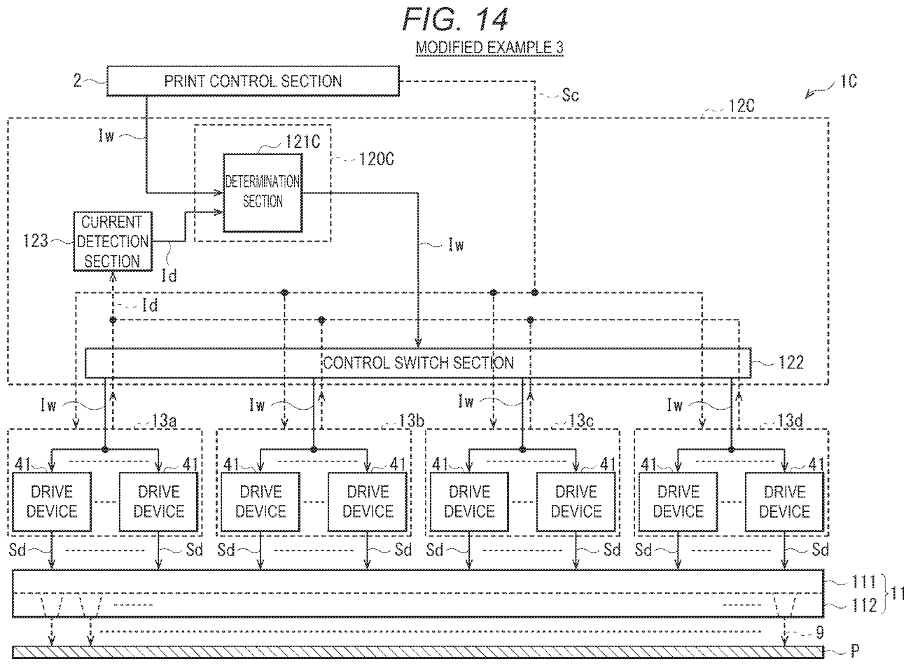

Further, an inkjet head 1C according to Modified Example 3 shown in FIG. 14 corresponds to what is provided with an I/F board 12C instead of the I/F board 12 in the inkjet head 1 (see FIG. 4) according to the embodiment. Further, the I/F board 12C corresponds to what is provided with a control device 120C including a determination section 121C described below instead of the control device 120 including the determination section 121 in the I/F board 12, and is further provided with a current detection section 123 described below.

It should be noted that the inkjet head 1C corresponds to a specific example of the “liquid jet head” in the present disclosure. Further, a printer equipped with the inkjet head 1C corresponds to a specific example of the “liquid jet recording device” in the present disclosure.

As shown in FIG. 14, the current detection section 123 described above is for obtaining information of the drive current Id generated when performing the ejection drive of the jet section 11 based on the drive signal Sd in the drive devices 41 in the plurality of flexible boards 13a through 13d. Specifically, first, it is arranged that the drive power included in the print control signal Sc is also supplied to the current detection section 123, and at the same time, a current detection resistor, for example, is disposed in the current detection section 123, and thus, detecting power is supplied to the drive devices 41 via the current detection resistor. Further, it is arranged that when performing the ejection drive of the jet section 11 by the drive devices 41, the drive current Id described above flows through the current detection resistor, and thus, a voltage drop generated in the current detection resistor is detected by an analog-digital converter, and is transmitted as a current detection value.

Further, the determination section 121C described above makes a determination on whether or not the drive current Id is a value within a predetermined current range ΔId (see FIG. 15C). It should be noted that the current range ΔId is a current range which fulfills ((a threshold current (a lower limit value)) Idth1)≤Id≤((a threshold current (an upper limit value)) Idth2) as shown in, for example, FIG. 15C.

Here, when the drive current Id is within the current range ΔId (Idth1≤Id≤Idth2), the determination section 121C makes the determination that the drive signal Sd should be output. In contrast, when the drive current Id is out of the current range ΔId (Idth1>Id or Id>Idth2), the determination section 121C makes the determination that the drive signal Sd should not be output. Incidentally, when a broken line occurs in, for example, the inside of the drive device 41, Id<Idth1 becomes true.

It should be noted that such a detection (measurement) of the drive current Id and the determination operation described above can be arranged to, for example, be performed on every nozzle hole Hn in the nozzle plate 112, or be performed every plurality of nozzle holes Hn at the same time as a unit.

(Functions/Advantages of Modified Example 1 through Modified Example 3)

Due to the configurations described above, the following functions and advantages, for example, can be obtained in Modified Example 1 through Modified Example 3.

First, in Modified Example 1, since the determination that the drive signal Sd should not be output is made when the drive voltage Vd in the drive signal Sd is a value out of the predetermined voltage range (out of the voltage range ΔVd described above), the following is achieved. That is, it is possible to take a variety of countermeasures against the false operation, the breakage, and so on of the inkjet head 1A caused by the drive signal Sd (abnormal setting of the drive voltage Vd) in which the drive voltage Vd is a value out of the voltage range ΔVd. As a result, it becomes possible to prevent the deterioration of the reliability of the inkjet head 1A caused by such an abnormality of the drive voltage Vd to thereby achieve an increase in reliability.

Further, in Modified Example 2, since the determination that the drive signal Sd should not be output is made when the device temperature Td in the drive devices 41 is a value out of the predetermined temperature range (out of the temperature range ΔTd described above), the following is achieved. That is, it is possible to take a variety of countermeasures against the false operation, the breakage, and so on of the inkjet head 1B caused by the situation (an abnormal state of the device temperature Td) in which the device temperature Td is a value out of the temperature range ΔTd. As a result, it becomes possible to prevent the deterioration of the reliability of the inkjet head 1B caused by such an abnormal state (a failure in the cooling system in the drive devices 41 and so on) of the device temperature Td to thereby achieve an increase in reliability.

Further, in Modified Example 3, since the determination that the drive signal Sd should not be output is made when the drive current Id generated when performing the ejection drive is a value out of the predetermined current range (out of the current range ΔId described above), the following is achieved. That is, it is possible to take a variety of countermeasures against the false operation, the breakage, and so on of the inkjet head 1C caused by the situation (an abnormal state of the drive current Id) in which the drive current Id is a value out of the current range ΔId. As a result, it becomes possible to prevent the deterioration of the reliability of the inkjet head 1C caused by such an abnormal state (an occurrence of short circuit in the jet section 11, a broken line of the electrical wiring line in the jet section 11, and so on) of the drive current Id to thereby achieve an increase in reliability.

### Modified Example 4

### (Configuration)

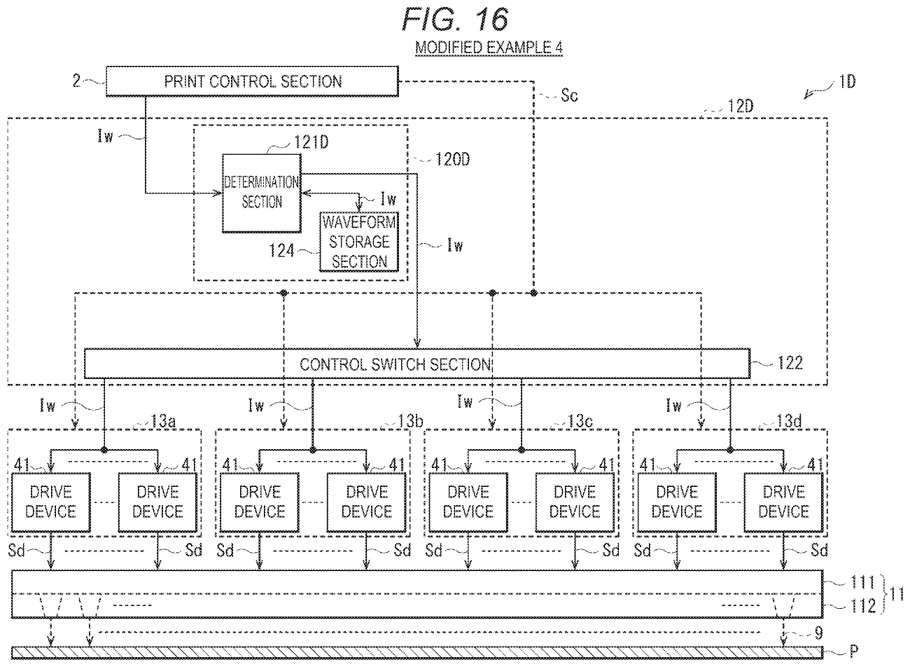

FIG. 16 is a block diagram showing a configuration example of a liquid jet head (an inkjet head 1D) according to Modified Example 4. The inkjet head 1D according to Modified Example 4 corresponds to what is provided with an I/F board 12D instead of the I/F board 12 in the inkjet head 1 (see FIG. 4) according to the embodiment.

It should be noted that the inkjet head 1D corresponds to a specific example of the “liquid jet head” in the present disclosure. Further, a printer equipped with the inkjet head 1D corresponds to a specific example of the “liquid jet recording device” in the present disclosure.

The I/F board 12D corresponds to what is provided with a control device 120D including a determination section 121D and a waveform storage section 124 described below instead of the control device 120 including the determination section 121 in the I/F board 12.

As shown in FIG. 16, the waveform storage section 124 is for storing the waveform configuration information Iw supplied from the outside (the print control section 2) of the inkjet head 1D. Such a waveform storage section 124 is configured using a variety of types of memory devices such as an EEPROM (Electrically Erasable Programmable Read-Only Memory).

Further, the determination section 121D is arranged to make the determination on whether or not the drive signal Sd should be output using a variety of methods described in, for example, the embodiment and Modified Example 1 through Modified Example 3 when reading out the waveform configuration information Iw stored in such a waveform storage section 124.

### (Functions/Advantages)

In such a manner, in Modified Example 4, since the waveform configuration information Iw supplied from the outside (the print control section 2) of the inkjet head 1D is stored in the waveform storage section 124, and at the same time, the determination on whether or not the drive signal Sd should be output is made when reading out the waveform configuration information Iw thus stored in the determination section 1D, the following is achieved.

That is, it is possible for the user of the inkjet head 1D automatically make the determination described above at, for example, the start-up of the inkjet head 1D only by storing the waveform configuration information Iw in the waveform storage section 124 in advance, and thus, it is possible to make the user regardless of the waiting time for the determination. Further, due to such a configuration, it becomes possible to, for example, store the waveform configuration information Iw in the waveform storage section 124 after correcting the waveform configuration included in the waveform configuration information Iw (overwrite save) in advance. This makes it possible to further increase the reliability of the inkjet head 1D while enhancing the convenience in Modified Example 4.

It should be noted that it is possible to arrange that, for example, other configuration information than the waveform configuration information Iw described above is stored in the waveform storage section 124. Specifically, it is possible to arrange that, for example, the setting for measuring the drive current Id described in Modified Example 3 is stored in the waveform storage section 124. When adopting this configuration, since it results in that the setting is written before shipment of the inkjet head 1D, and the setting for measuring the drive current Id is automatically performed when the user uses the inkjet head 1D, it becomes possible to prevent an error in setting by the user. Further, it is possible to arrange that information of a usage history such as start-up time and the number of times of ejection of the inkjet head 1D is stored in the waveform storage section 124. When adopting this configuration, it becomes possible for the user to figure out, for example, an indication of the time for replacement of the inkjet head 1D.

### Modified Example 5

### (Configuration)

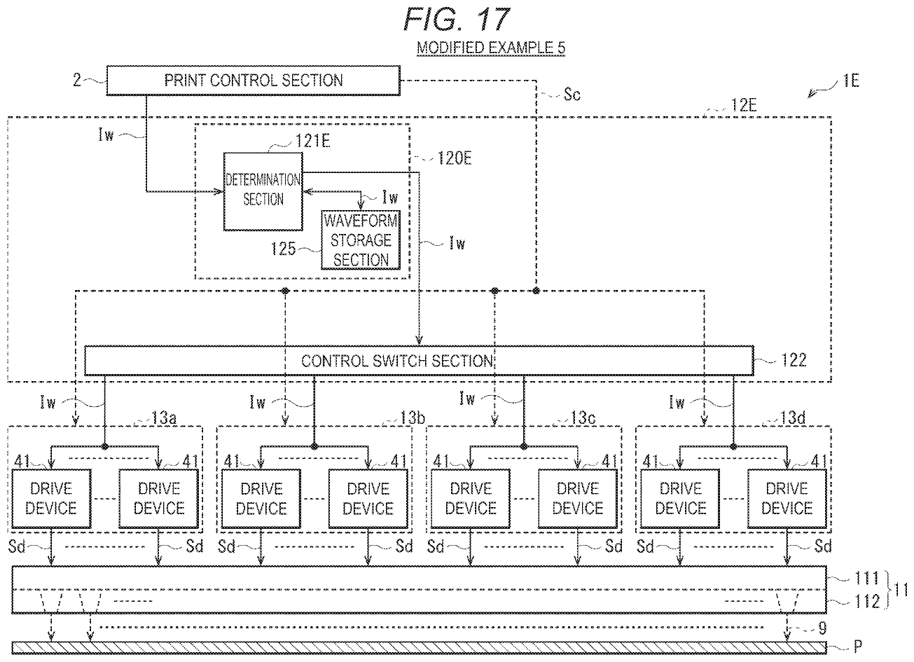

FIG. 17 is a block diagram showing a configuration example of a liquid jet head (an inkjet head 1E) according to Modified Example 5. The inkjet head 1E according to Modified Example 5 corresponds to what is provided with an I/F board 12E instead of the I/F board 12 in the inkjet head 1 (see FIG. 4) according to the embodiment.

It should be noted that the inkjet head 1E corresponds to a specific example of the “liquid jet head” in the present disclosure. Further, a printer equipped with the inkjet head 1E corresponds to a specific example of the “liquid jet recording device” in the present disclosure.

The I/F board 12E corresponds to what is provided with a control device 120E including a determination section 121E and a waveform correction section 125 described below instead of the control device 120 including the determination section 121 in the I/F board 12.

When it is determined that the drive signal Sd should not be output in the determination section 121E using a variety of methods described in, for example, the embodiment and Modified Example 1 through Modified Example 3, the waveform correction section 125 perform the correction of the waveform configuration information Iw so that it is determined that the drive signal Sd should be output. Specifically, when it is determined that the drive signal Sd should not be output on the grounds that, for example, the predetermined abnormal waveform configuration (see, e.g., FIG. 9 through FIG. 11) described above is included in the waveform configuration information Iw, the waveform correction section 125 performs the correction of the waveform configuration information Iw in which such an abnormal waveform configuration is changed to the normal waveform configuration (see FIG. 5). Alternatively, when the determination that the drive signal Sd should not be output is made on the grounds that, for example, the drive voltage Vd, the device temperature Td, and the drive current Id described above become the values out of the predetermined ranges described above, the waveform correction section 125 performs the correction of the waveform configuration information Iw so that the values fall within the predetermined ranges, respectively.

Specifically, when, for example, the drive current Id or the device temperature Td exceeds the upper limit value described above, the waveform correction section 125 performs the correction of the waveform configuration information Iw so that the crest value in the drive voltage Vd lowers. Alternatively, the waveform correction section 125 performs the correction of the waveform configuration information Iw so that the drive voltage Vd falls within the voltage range ΔVd in accordance with the control of the determination section 121E. Further, it is possible to arrange that the drive waveform with which the current consumption becomes the highest is detected in advance, and when the drive current Id or the device temperature Td exceeds the upper limit value described above, the drive waveform previously detected is deleted to thereby perform the correction of the waveform configuration information Iw.

### (Functions/Advantages)

In such a manner, in Modified Example 5, when it is determined that the drive signal Sd should not be output, the correction of the waveform configuration information Iw is performed in the waveform correction section 125 so that it is determined that the drive signal Sd should be output, and therefore, the following is achieved. That is, since such a correction of the waveform configuration information Iw is performed, and thus, the waveform configuration information Iw is corrected so that it is determined that the drive signal Sd should be output, it is possible to actually prevent the false operation, the breakage, and so on of the inkjet head 1E, and thus, it becomes possible to further increase the reliability of the inkjet head 1E.

### Modified Example 6

### (Configuration)

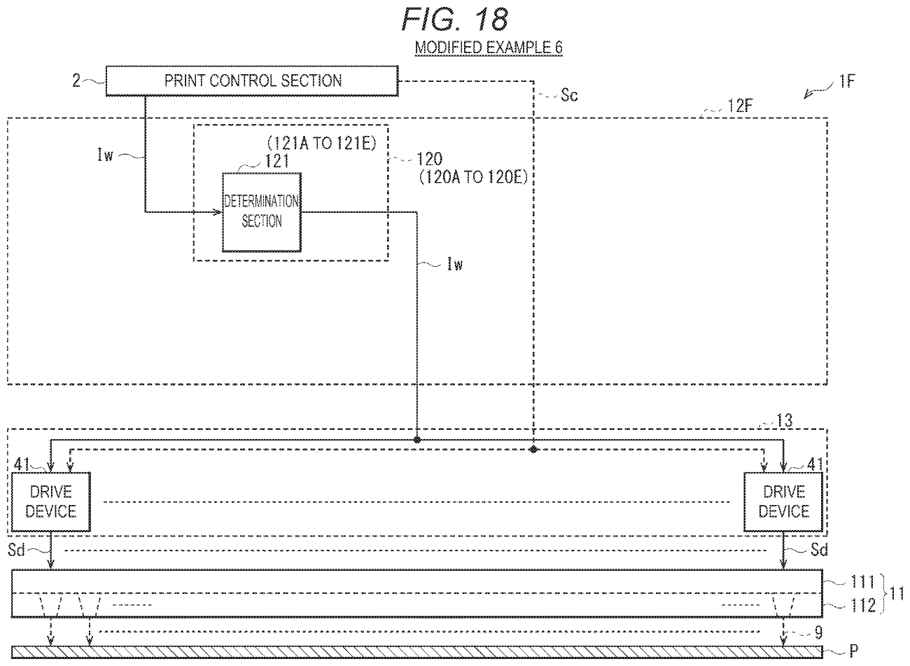

FIG. 18 is a block diagram showing a configuration example of a liquid jet head (an inkjet head 1F) according to Modified Example 6. The inkjet head 1F according to Modified Example 6 corresponds to what is provided with an I/F board 12F instead of the I/F board 12, and at the same time, provided with a single flexible board 13 instead of the plurality of flexible boards 13a through 13d in the inkjet head 1 (see FIG. 4) according to the embodiment.

It should be noted that the inkjet head 1F corresponds to a specific example of the “liquid jet head” in the present disclosure. Further, a printer equipped with the inkjet head 1F corresponds to a specific example of the “liquid jet recording device” in the present disclosure. Further, the flexible board 13 described above corresponds to a specific example of the “drive board” in the present disclosure.

The flexible board 13 described above is substantially the same in configuration as each of the flexible boards 13a through 13d described in the embodiment.

In the I/F board 12F described above, any one of the control devices 120, and 120A through 120E described hereinabove (see FIG. 18) is provided instead of the control device 120 in the I/F board 12. It should be noted that the control devices 120, and 120A through 120E each include at least one of the determination sections 121, and 121A through 121E as described hereinabove.

Further, unlike the I/F boards 12A through 12E described hereinabove, the I/F board 12F has a configuration of eliminating (omitting) the control switch section 122 due to the configuration of providing the single flexible board 13 described above. Therefore, as shown in FIG. 18, in the inkjet head 1F in Modified Example 6, it is arranged that the print control signal Sc and the waveform configuration information Iw are each directly (without the intervention of the control switch section 122) supplied to each of the drive devices 41 in the flexible board 13.

### (Functions/Advantages)

In Modified Example 6 having such a configuration, it is also possible to obtain basically the same advantages due to substantially the same function as that of the embodiment and Modified Example 1 through Modified Example 5 described hereinabove.

### 3. Other Modified Examples

The present disclosure is described hereinabove citing the embodiment and some modified examples, but the present disclosure is not limited to the embodiment and so on, and a variety of modifications can be adopted.

For example, in the embodiment and so on described above, the description is presented specifically citing the configuration examples (the shapes, the arrangements, the number and so on) of each of the members in the printer and the inkjet head, but those described in the above embodiment and so on are not limitations, and it is possible to adopt other shapes, arrangements, numbers and so on.

Specifically, for example, in the embodiment and so on described above, the description is presented specifically citing the configuration examples of the I/F board, the flexible board (the drive board), the drive device, the control device, and so on, but these configuration examples are not limited to those described in the above embodiment and so on. For example, in the embodiment and so on described above, the description is presented citing when the “drive board” in the present disclosure is the flexible board as an example, but the “drive board” in the present disclosure can also be, for example, an inflexible board.

Further, the numerical examples of the variety of parameters described in the embodiment and so on described above are not limited to the numerical examples described in the embodiment and so on, and can also be other numerical values. Further, the data configuration example of the waveform configuration information described in the above embodiment and so on is not limited to the example described in the above embodiment and so on, and can also be other data configurations.

In addition, the determination operation, the correction operation of the waveform configuration information, the ejection stop operation, the notification operation of the error information, and so on are not limited to the operation examples described in the above embodiment and so on, and other operation examples can also be adopted.

Specifically, it is possible to arrange that other determination functions (an error detection function) are added in the determination section. Specifically, it is arranged that, for example, whether or not erroneous setting is performed by the user is detected inside the drive device 41, and when such erroneous setting is detected, the forced outage of the ejection operation of the ink 9 is performed. For example, when there occurs the state in which a setting pin is not correctly set due to an installation failure or an impact during use although the operation setting is made with the setting pin of the drive device 41, it is not desirable to perform the drive in the present state in some cases although the correct setting as the inkjet head is made in the drive devices. In such a case, it is possible to arrange that the drive device 41 by itself detects the fact that the setting made to the drive device and the drive waveform configuration suitable for the setting are mismatched, and then, performs the forced outage of the ejection operation of the ink 9.

Further, as the structure of the inkjet head, it is possible to apply those of a variety of types. Specifically, for example, it is possible to adopt a so-called side-shoot type inkjet head which emits the ink 9 from a central portion in the extending direction of each of the ejection channels in the actuator plate 111. Alternatively, it is possible to adopt, for example, a so-called edge-shoot type inkjet head for ejecting the ink 9 along the extending direction of each of the ejection channels. Further, the type of the printer is not limited to the type described in the embodiment and so on described above, and it is possible to apply a variety of types such as an MEMS (Micro Electro-Mechanical Systems) type.

Further, for example, it is possible to apply the present disclosure to either of an inkjet head of a circulation type which uses the ink 9 while circulating the ink 9 between the ink tank and the inkjet head, and an inkjet head of a non-circulation type which uses the ink 9 without circulating the ink 9.

Further, the series of processes described in the embodiment and so on described above can be arranged to be performed by hardware (a circuit), or can also be arranged to be performed by software (a program). When arranging that the series of processes is performed by the software, the software is constituted by a program group for making the computer perform the functions. The programs can be incorporated in advance in the computer described above and are then used, for example, or can also be installed in the computer described above from a network or a recording medium and are then used. It should be noted that as a recording medium (a non-transitory computer-readable recording medium) on which such programs are recorded, there can be cited a variety of types of media such as a floppy (a registered trademark) disk, a CD (Compact Disk)-ROM, a DVD (Digital Versatile Disc)-ROM, and a hard disk.

Further, in the above embodiment and so on, the description is presented citing the printer (the inkjet printer) as a specific example of the “liquid jet recording device” in the present disclosure, but this example is not a limitation, and it is also possible to apply the present disclosure to other devices than the inkjet printer. In other words, it is also possible to arrange that the “liquid jet head” (the inkjet head) of the present disclosure is applied to other devices than the inkjet printer. Specifically, it is also possible to arrange that the “liquid jet head” of the present disclosure is applied to a device such as a facsimile or an on-demand printer.

In addition, it is also possible to apply the variety of examples described hereinabove in arbitrary combination.

It should be noted that the advantages described in the present specification are illustrative only, but are not a limitation, and other advantages can also be provided.

Further, the present disclosure can also take the following configurations.

<1> A control device to be applied to a liquid jet head having a jet section configured to jet liquid, the control device comprising a determination section configured to determine whether to output a drive signal based on waveform configuration information supplied from an outside of the liquid jet head to the jet section from a drive device configured to generate the drive signal based on the waveform configuration information.

<2> The control device according to <1>, wherein the determination section makes the determination that the drive signal is not to be output when a predetermined abnormal waveform configuration is included in the waveform configuration information.

<3> The control device according to <2>, wherein the waveform configuration information includes power supply potential value information in which a power supply potential value selected from a plurality of power supply potential values is set along a time axis, and a reference potential value, a positive potential value, and an intermediate potential value intermediate between the reference potential value and the positive potential value as the plurality of power supply potential values, and the determination section makes the determination that the drive signal is not to be output when a first abnormal waveform configuration as the predetermined abnormal waveform configuration in which the drive signal does not step at the intermediate potential value in a transition between the reference potential value and the positive potential value is included in the power supply potential value information in the waveform configuration information.

<4> The control device according to <2> or <3>, wherein the waveform configuration information includes power supply potential value information in which a power supply potential value selected from a plurality of power supply potential values is set along a time axis, and a reference potential value, a positive potential value, and a negative potential value as the plurality of power supply potential values, and the determination section makes the determination that the drive signal is not to be output when a second abnormal waveform configuration as the predetermined abnormal waveform configuration in which the drive signal does not step at the reference potential value in a transition between the negative potential value and the positive potential value is included in the power supply potential value information in the waveform configuration information.

<5> The control device according to any one of <2> to <4>, wherein the waveform configuration information includes power supply potential value information in which a power supply potential value selected from a plurality of power supply potential values is set along a time axis, at least one of the power supply potential values among the plurality of power supply potential values includes a plurality of types of power supply potential values corresponding respectively to supply values from power supply lines different from each other, and the determination section makes the determination that the drive signal is not to be output when a third abnormal waveform configuration as the predetermined abnormal waveform configuration in which there is a configuration of using the power supply potential value of a same type out of the plurality of types of power supply potential values a number of times no smaller than a predetermined number of times in a unit period of time is included in the power supply potential value information in the waveform configuration information.

<6> The control device according to any one of <1> to <5>, wherein the determination section makes the determination that the drive signal is not to be output when a drive voltage in the drive signal is a value out of a predetermined voltage range.

<7> The control device according to any one of <1> to <6>, wherein the determination section makes the determination that the drive signal is not to be output when a device temperature in the drive device is a value out of a predetermined temperature range.

<8> The control device according to any one of <1> to <7>, wherein the determination section makes the determination that the drive signal is not to be output when a drive current generated when performing ejection drive on the jet section based on the drive signal is a value out of a predetermined current range.

<9> The control device according to any one of <1> to <8>, further comprising a waveform storage section configured to store the waveform configuration information supplied from the outside of the liquid jet head, wherein the determination section makes the determination on whether to output the drive signal when reading out the waveform configuration information stored in the waveform storage section.

<10> The control device according to any one of <1> to <9>, wherein the determination section outputs an ejection stop signal for stopping jetting of the liquid from the jet section to the drive device, and gives an error notification to the outside of the liquid jet head when the determination section determines that the drive signal is not to be output.

<11> The control device according to any one of <1> to <10>, further comprising a waveform correction section configured to perform a correction of the waveform configuration information so that a determination that the drive signal is to be output is made when the determination section determines that the drive signal is not to be output.

<12> A liquid jet head comprising: the control device according to any one of <1> to <11>; the jet section; and the drive device or a plurality of the drive devices configured to apply the drive signal to the jet section to thereby jet the liquid.

<13> A liquid jet recording device comprising the liquid jet head according to <12>.

<14> A control program to be applied to a liquid jet head having a jet section configured to jet liquid, the control program comprising: determining whether to output a drive signal based on waveform configuration information supplied from an outside of the liquid jet head to the jet section from a drive device configured to generate the drive signal based on the waveform configuration information.

<15> A non-transitory computer-readable storage medium storing a control program to be applied to a liquid jet head having a jet section configured to jet liquid, the control program comprising: determining whether to output a drive signal based on waveform configuration information supplied from an outside of the liquid jet head to the jet section from a drive device configured to generate the drive signal based on the waveform configuration information.

What is claimed is:

1. A control device to be applied to a liquid jet head having a jet section configured to jet liquid, the control device comprising a determination section configured to determine whether to output a drive signal based on waveform configuration information supplied from an outside of the liquid jet head to the jet section from a drive device configured to generate the drive signal based on the waveform configuration information.

2. The control device according to claim 1, wherein
the determination section makes the determination that the drive signal is not to be output when a predetermined abnormal waveform configuration is included in the waveform configuration information.

3. The control device according to claim 2, wherein
the waveform configuration information includes
power supply potential value information in which a power supply potential value selected from a plurality of power supply potential values is set along a time axis, and
a reference potential value, a positive potential value, and an intermediate potential value intermediate between the reference potential value and the positive potential value as the plurality of power supply potential values, and
the determination section makes the determination that the drive signal is not to be output when a first abnormal waveform configuration as the predetermined abnormal waveform configuration in which the drive signal does not step at the intermediate potential value in a transition between the reference potential value and the positive potential value is included in the power supply potential value information in the waveform configuration information.

4. The control device according to claim 2, wherein
the waveform configuration information includes
power supply potential value information in which a power supply potential value selected from a plurality of power supply potential values is set along a time axis, and
a reference potential value, a positive potential value, and a negative potential value as the plurality of power supply potential values, and
the determination section makes the determination that the drive signal is not to be output when a second abnormal waveform configuration as the predetermined abnormal waveform configuration in which the drive signal does not step at the reference potential value in a transition between the negative potential value and the positive potential value is included in the power supply potential value information in the waveform configuration information.

5. The control device according to claim 2, wherein
the waveform configuration information includes power supply potential value information in which a power supply potential value selected from a plurality of power supply potential values is set along a time axis,
at least one of the power supply potential values among the plurality of power supply potential values includes a plurality of types of power supply potential values corresponding respectively to supply values from power supply lines different from each other, and
the determination section makes the determination that the drive signal is not to be output when a third abnormal waveform configuration as the predetermined abnormal waveform configuration in which there is a configuration of using the power supply potential value of a same type out of the plurality of types of power supply potential values a number of times no smaller than a predetermined number of times in a unit period of time is included in the power supply potential value information in the waveform configuration information.

6. The control device according to claim 1, wherein
the determination section makes the determination that the drive signal is not to be output when a drive voltage in the drive signal is a value out of a predetermined voltage range.

7. The control device according to claim 1, wherein
the determination section makes the determination that the drive signal is not to be output when a device temperature in the drive device is a value out of a predetermined temperature range.

8. The control device according to claim 1, wherein
the determination section makes the determination that the drive signal is not to be output when a drive current generated when performing ejection drive on the jet section based on the drive signal is a value out of a predetermined current range.

9. The control device according to claim 1, further comprising a waveform storage section configured to store the waveform configuration information supplied from the outside of the liquid jet head, wherein
the determination section makes the determination on whether to output the drive signal when reading out the waveform configuration information stored in the waveform storage section.

10. The control device according to claim 1, wherein
the determination section outputs an ejection stop signal for stopping jetting of the liquid from the jet section to the drive device, and gives an error notification to the outside of the liquid jet head when the determination section determines that the drive signal is not to be output.

11. The control device according to claim 1, further comprising a waveform correction section configured to perform a correction of the waveform configuration information so that a determination that the drive signal is to be output is made when the determination section determines that the drive signal is not to be output.

12. A liquid jet head comprising:
the control device according to claim 1;
the jet section; and
the drive device or a plurality of the drive devices configured to apply the drive signal to the jet section to thereby jet the liquid.

13. A liquid jet recording device comprising the liquid jet head according to claim 12.

14. A non-transitory computer-readable storage medium storing a control program to be applied to a liquid jet head having a jet section configured to jet liquid, the control program comprising:
determining whether to output a drive signal based on waveform configuration information supplied from an outside of the liquid jet head to the jet section from a drive device configured to generate the drive signal based on the waveform configuration information.
